(19) United States
(12) Patent Application Publication
(10) Pub. No.: US 2003/0220903 A1
(43) Pub. Date: Nov. 27, 2003

(54) Long-term digital storage

(76) Inventors: Marco Casassa Mont, Bristol (GB); Andrew Patrick Norman, Bristol (GB); Simon Shiu, Bristol (GB); Adrian Baldwin, Bristol (GB); Keith Alexander Harrison, Woodcroft Chepstow (GB)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/414,993

(22) Filed: Apr. 16, 2003

(30) Foreign Application Priority Data
Apr. 19, 2002 (GB) 0208967.0

(51) Int. Cl. G06F 7/00

(52) U.S. Cl. 707/1

(57) ABSTRACT

A long-term digital document storage system, comprising means for receiving one or more digital documents for storage in a storage means, one or more storage sites for storing, in association with the one or more digital documents, metadata defining a data management strategy or “agreement” with respect to the one or more digital documents, the “agreement including one or more “clauses” defining respective constraints to be applied by the storage system to the one or more digital documents, the system further comprising means for configuring the data management strategy or agreement by defining or specifying at least some of the constraints individually according to specific requirements related to said one or more pieces of digital data. As such, the invention is concerned with the fine-grained management of documents within a storage system by the flexible definition and association with a document of a number of clauses (i.e. management constraints to be fulfilled by the storage system) concerning the required management of that document.

### FIELD OF THE INVENTION

This invention relates to long-term digital storage of documents and other data and, in particular, to the long-term, secure retention and management of electronic documents and the like.

### BACKGROUND TO THE INVENTION

There are many circumstances, both policy and legislation-related, in which it may be required to retain documents for relatively long periods of time, for future retrieval and review if required. Particularly in the case of commercial enterprises and businesses, many different types of document are required to be retained for varying periods of time. For example, current UK legislation requires (paper) receipts to be kept for 7 years, and aircraft manufacturing designs are typically kept for decades.

Traditionally, such document retention has usually been achieved by means of a paper filing system using files and filing cabinets or the like, which may be locked or stored in a secure environment as required, with access thereto being restricted or limited to certain predetermined personnel. However, the physical space and resources required to adequately maintain such a storage system are often inconvenient. Particularly as more and more business documentation becomes computerised, the above-mentioned filing system becomes even more impractical and difficult to manage to the required standard. Thus, the need for a long-term, secure electronic document storage system is clear.

The management of electronic documents is relatively complex (compared to the paper-based management of documents) in that the integrity and confidentiality of such electronic documents must be maintained whilst ensuring that documents, say stored 10 years ago, are readable on the latest generation of computer systems. As such, digital records tend to be encrypted prior to storage so as to prevent unauthorised access to their contents.

Digital records can be encrypted and decrypted using cryptography, the branch of applied mathematics that concerns itself with transforming digital documents into seemingly unintelligible forms and back again. One known type of cryptography uses a methodology which employs an algorithm using two different but mathematically related “keys”, one for transforming data into a seemingly unintelligible form, and one for returning the message to its original form. Although the two keys are mathematically related, if the document storage system is designed and implemented securely, it should be computationally infeasible to derive the private key from knowledge of the public key.

Further, a digital record may be digitally signed for added authenticity. Digital signature creation uses a hash value derived from, and unique, to both the signed record and a given private key. Such a hash value is created using a hash function which is an algorithm which creates a digital representation (i.e. hash value) of a standard length which is usually much smaller than the digital record it represents but nevertheless substantially unique to it. Any change to the record should invariably produce a different hash value when the same hash function is used, i.e. for the hash value to be secure, there must be only a negligible possibility that the same digital signature could be created by the combination of any other message or private key. To associate a key pair with a prospective signer (to confirm their integrity), a certification authority issues a certificate, which is an electronic record which lists a public key as the “subject” of a certificate and confirms that the prospective signer listed in the certificate holds the private key.

However, private and public keys are simply n-bit numbers and, as the computational and processing ability of modern systems increases over time, so the number of bits required to be used for such keys must be increased in order to ensure that a “trial and error” approach, which could otherwise be used to decrypt a piece of data which has been encrypted using a private key (by simply trying all of the possible combinations of the respective public key) remains computationally infeasible according to up-to-date processor abilities. Thus, the digital signature applied to a digital record needs to be updated periodically in order to ensure that the authenticity of the record is maintained over a long period of time. Further, digital certificates are only valid for a predetermined period of time, typically one year, and need to be renewed regularly.

Another issue to be considered in the long-term storage of digital documents is the rendering tool used to create such documents. Rendering tools, such as word processing software packages and the like, tend to be updated and new versions issued on a regular basis. Thus, the rendering tool used to create a document, say, 10 years ago would now be very out-of-date such that the document is no longer readable using current software and equipment. Thus, some consideration needs to be given to the re-versioning of such documents so that they are still readable many years after their creation and storage.

Thus, there are a number of critical issues which need to be considered in the implementation of a long-term digital document storage system, as follows:

ensuring that records are not unintentionally lost, even if they are stored for decades or more;

maintaining and ensuring the integrity of records;

controlling the confidentiality of stored records;

maintaining ownership and/or access control details for records;

preserving the context of a record (e.g. an e-mail created 8 years ago will be fairly meaningless without an indication of the conversation of which it was a part);

preserving trust properties associated with a record.

The significance of these issues with respect to any particular document or set of documents will be dependent upon the length of time it is required to be stored, the level of confidentiality/importance is associated with it, the trust properties associated with it, etc. Therefore, the management of documents or sets of documents will vary according to these and other variables, and it is this document management to which the present invention is concerned.

Current storage solutions “macro-manage” documents according to general purpose policies or predefined storage management classes. This approach is simple from an implementation point of view but it does not satisfy the specific “micro-management” needs and requirements of the owners of many types of stored document. In general, each stored document potentially needs to be uniquely managed, depending on its nature, content and level of importance, according to constraints specified by the owner or the law, for example. This is even more important when documents are stored for a relatively long period of time, and current document management strategies do not fulfil these requirements.

We have now devised an arrangement which addresses this problem.

### SUMMARY OF THE INVENTION

Thus in accordance with the present invention, there is provided a digital data storage system arranged to receive one or more pieces of digital data for storage in an electronic data storage location, and to store in association with said one or more pieces of digital data, metadata defining a predetermined data storage management strategy with respect to said one or more pieces of digital data, said metadata defining one or more actions required to be taken by said storage system in respect of said one or more pieces of digital data in order to comply with said data storage management strategy, the system comprising configuring apparatus for configuring said data storage management strategy by defining or specifying at least some of said actions individually according to specific requirements related to said one or more pieces of digital data.

Also in accordance with the present invention, there is provided a method of digital data storage, the method comprising the steps of receiving one or more pieces of digital data for storage in a storage means, storing in association with said one or more pieces of digital data metadata defining a predetermined data storage management strategy, said data storage management strategy defining one or more actions required to be taken in respect of said one or more pieces of digital data in order to comply with said data storage management strategy, implementing said constraints as defined by said data storage management strategy, the method further comprising the step of configuring said data storage management strategy by defining or specifying at least some of said one or more actions individually according to specific requirements related to said one or more pieces of digital data.

Still further in accordance with the present invention, there is provided a digital data storage system, arranged to receive one or more digital documents for storage in a memory device, generate metadata defining a predetermined document storage management strategy with respect to said one or more digital documents, and store said metadata together with said respective one or more digital documents, said metadata defining one or more operations required to be performed by said storage system in respect of said one or more digital documents in order to comply with said document storage management strategy, and the system comprising a configuring system for configuring said document storage management strategy by defining or specifying at least some of said operations individually according to specific requirements relating to said one or more digital documents.

Thus, the present invention is concerned with the fine-grained management of documents within a storage system by the flexible definition and association with a document of a number of clauses (i.e. management constraints to be fulfilled by a storage system) concerning the management of that document. For example, a data management strategy or “agreement” associated with a particular document may require that the trusted signature is renewed every two years, the time stamp is renewed every year and the format of the document is renewed each time a new version of the rendering tool is released, whereas another document may require that the trusted signature is renewed every year and the time stamp is renewed every six months. In other words, the agreements associated with, and governing the management of a stored document is flexible and configurable according to user requirements, such that, if required, a unique agreement can be defined for and associated with each stored document.

It will be appreciated that the data management strategy (or agreement) can be considered to define a “contract” between the owner of the document and the storage system. It might include storage and management clauses such as the number of replicas of the document are required to be made and stored, encryption and time stamping requirements, document renewal requirements, etc. and each document (or set of documents) is preferably stored along with its own storage agreement.

The agreements can be stored as documents in themselves, together with a time stamp and/or digital signature, if required. Further, an agreement may have one or more other agreements associated thereto defining its management strategy. The last of a set of agreements ultimately associated to a document preferably defines its own management strategy (i.e. a “root agreement”).

It is preferably possible to define hierarchies of agreements starting from high level (and generic) agreements to very specific and detailed agreements. Any of these agreements can be associated with a stored document, and the hierarchy of agreements can be defined as a set of links between these documents. Further, multiple agreements might be associated to a particular document (or set of documents), ranging for example from general purpose to specific agreements. As a consequence, circumstances may arise in which the terms of two clauses of different agreements associated to the same document may conflict. In order to deal with such a situation, a preferred embodiment of the present invention includes means for defining a set of rules for resolving such conflicts.

The main advantage of the present invention is the flexibility it provides both to the document storage system and to its users. Instead of “force fitting documents into predefined storage management classes, the system allows each document to be individually managed according to specific requirements and needs. A user is not constrained by the management limitation of the system and can freely define the best management clauses that fit their needs. The invention is further flexible in that the scope of an agreement can range from a single stored document to a class of documents that share the same storage requirements.

Another advantage of the invention lies in the fact that it is possible to set up policies for how known classes of documents should be stored and managed. Moreover, it is relatively easy to raise exceptions to known agreements. A combination of these two makes the integration of the service to existing processes possible. For example, if e-mails were automatically passed to the service, it is possible to implement a company policy, say, to delete all e-mails within two years. Moreover, the invention also allows (in a controlled way) individuals to specify exceptions for their e-mails. As another example, consider a third party contract fulfilment service according to an exemplary embodiment of the present invention. Such a service could specify agreements for how contracts are stored, and ensure that all authenticity properties are retained. Moreover, as evidence of contract fulfilment is collected, such evidence can also be stored with the service, and held within related contexts.

### BRIEF DESCRIPTION OF THE DRAWINGS

An embodiment of the present invention will now be described by way of example only and with reference to the accompanying drawings, in which:

FIG. 1 is a schematic diagram illustrating the relationships between a document, an associated agreement and the active storage service of an exemplary embodiment of the present invention;

FIG. 2 is a schematic diagram illustrating a user's view of a storage system according to an exemplary embodiment of the present invention;

FIG. 3 is a schematic diagram illustrating the process of storing an electronic record in a storage system according to an exemplary embodiment of the present invention;

FIG. 4 is a schematic diagram illustrating the object hierarchy of data, documents and structures within a storage system according to an exemplary embodiment of the present invention;

FIG. 5 is a simple agreement association graph involving both documents and agreements;

FIG. 6 is a simple agreement hierarchy involving both documents and agreements;

FIG. 7 is a schematic diagram illustrating the architecture of a storage system according to an exemplary embodiment of the present invention;

FIG. 8 is a schematic diagram illustrating the structure of a service pool used in the system of FIG. 7;

FIG. 9 is a schematic diagram illustrating the interpretation of agreements in a storage system according to an exemplary embodiment of the present invention;

FIG. 10 is a schematic diagram illustrating a proxynode;

FIG. 11 is a schematic block diagram of a storage system according to an exemplary embodiment of the present invention;

FIG. 12 is a schematic block diagram illustrating a distributed index service for use in a storage system according to an exemplary embodiment of the present invention;

FIG. 13 is a schematic diagram illustrating the high level architecture of an index service forming part of the distributed index service of FIG. 13;

FIG. 14 illustrates a proxynode retrieval algorithm for use in a storage system according to an exemplary embodiment of the present invention;

FIG. 15 illustrates an algorithm implementing the “logical” lock of a distributed set of proxynode replicas for use in a storage system according to an exemplary embodiment of the present invention; and

FIG. 16 illustrates a synchronisation algorithm implemented by each index manager in a storage system according to an exemplary embodiment of the present invention.

### DETAILED DESCRIPTION OF THE INVENTION

To aid in the understanding of the following description of a preferred exemplary embodiment of the present invention, an overview of the functionality of an exemplary active storage system including an exemplary embodiment of the present invention will first be given.

Thus, a three-layer storage architecture is proposed, as illustrated in FIG. 12 of the drawings. Each layer consists of a number of duplicate functional units that can be distributed around a (potentially global) network. An index (to be described later) or the document to be stored will be replicated over a random subset of the indexes and stores.

A user can enter documents for storage by the system via the portal layer. Upon entry of a document, the user provides the document and a set of conditions (the “agreement”) under which it is to be managed. The document may be a raw set of bits or it could be some form of collection of other documents. Upon submission of the document to the system, the user will receive back a name (and upon submission of that name, the user can receive back the document). It should be noted that a managed document will be represented in the system as a set of documents (including the documents required for management of the stored data) and the user is actually given the (unique) name of the document collection (assigned by the system). Upon submission of the name, the user will be provided (by default) the ‘current’ version of the document, although any version thereof can be recovered.

Thus, the user who wishes to store or access information operates through the portal layer. As far as the user is concerned, this is in fact the storage service, although they could switch to alternative portals if they are mobile or a particular portal fails, for example. In any event, precisely the same storage service would be accessed. For a store operation, the portal will choose from a list of index sites at random or using some management data allowing it to identify the least loaded or most local index sites. For a recovery or update operation, the portal uses the document name as a routing mechanism (see below for further discussion concerning the name). The name suggests which index nodes contain the document and the portal can choose one of the index nodes at random or use some management data to direct the request. This allows the portal to reach one of the index nodes containing information about the document.

The index layer consists of a number of distributed index sites. Each index site consists of some form of database containing information about the document being stored and a pool of processes where the various storage services and information management services can be run. These processes will support add, retrieve and update functions of the storage service. Other processes supported include a long-term scheduler which ensures that the correct tasks are run with respect to the stored documents as either inernal or external processes.

Upon entry of a new piece of information, the add function will store n copies of the raw data in the basic storage services (chosen at random—or with the required access properties). These copies may be encrypted with additional nonces to vary lengths. A name is then generated which defines the replicated index nodes to be used. A ‘proxy node’ is created containing information about where the raw data files are, some representation of their encryption keys, management information, access control information and metadata. This proxy node is then added to all the indexes implied by the name. If some of these nodes have failed, the updates can be delayed until those index services come back up. The name is then returned to the user (note that it may be possible to return the name early when the system has sufficient replication).

For the retrieval process, the index node will look in its local database for a proxy node telling the system where to look for the real documents. One storage site is chosen and the data is recovered, checked, possibly decrypted and re-encrypted before being returned to the user (via the portal).

The update operation, which allows structured data to be extended, is more complex in that the proxy node must be locked. The data in the raw store is recovered from one node and updated according to the request. The raw store data is then updated or new copies are made with the appropriate changes being made to the proxy node in the database. The node can then be unlocked.

Thus, the proxy node contains access control information for the documents, and the index layer validates the update and retrieval operations before they are made. The index layer contains a long-term scheduler which ensures that management processes are run to form new versions of the data which are placed into list structures holding version information. Deletion is one of the management tasks but it can only be undertaken under strict control. The deletion operation itself is similar to the retrieve and update operations, although it can be a two-stage operation with the first stage being to delete the data and the second stage being to delete the proxy node when all internal references to the data have expired.

The storage layer is constructed from a large number of simple storage elements that store raw bits under given names. Given the name, they will pass the data back to the correctly authenticated index nodes.

The name consists of three components: a unique name service id, a unique number and a list of index numbers. As such, the name is guaranteed to be unique. It will be appreciated that the name is intended to provide means for the portal layer to derive a mapping table or the like to the associated stored data, as opposed to providing a clear indication as to its location. There is a location table that is indexed by the name service and the list of index numbers to give the index service locations. This naming scheme has the advantage that the user will not know about the index manager locations (and the name does not have to include the full data). It also makes it easier to replace the index services with alternative services. The portal may be implemented as a web service to which the user connects. The portal has an address translation table which allows the list of index servers to be found from the name.

Variations of this could include a digitally signed name such that its validity can be checked, or an encrypted name such that the name decrypts into particular structures both to validate it and hide the structure from the user. Further information could be included in the name, or overloaded into the authority name. In this way, the name could also be used as a storage receipt.

The storage system described above in general terms relates to a trusted store architecture which provides a robust replicated store that also enables the management tasks to be run. Some of the advantages provided by this architecture include the fact that it is easy to add capacity (i.e. it can be scaled according to requirements), survivability (the ability of the service to keep running in the event of system failures or attacks), safety of data (even when failures occur), the fact that it supports management processes to maintain the integrity of the data, and it supports collections of data (to support the outcomes of various management processes).

Thus, in summary, a replicated storage architecture is proposed which allows multiple copies of both data and associated meta and management data to be stored. This architecture includes an index layer and a storage layer. The index layer consists of multiple index sites which contain multiple copies of each piece of metadata. These index sites also include management processes, thereby ensuring that all necessary operations can be carried out on the data—including deletion. The raw storage layer consists of multiple storage sites that store multiple copies of the data. The location of the index material and the data is decided at random and obscured from the user. The data can either be a byte stream or it can be structured data, which allows for versioning and for the managed retention of sets of data. The base form of data can be stored and recovered with the appropriate access control. The structured data can consist of list structures that can only be extended—this ensures that no data can be changed, only deleted as specified in a management agreement. Structured data is managed such that other pieces of data referred to in the structures are managed for the lifetime of the references. This means that deletion dates can be extended or tombstones, recalling deletion details, can be created.

Upon the addition of each piece of data to the system, a set of management requirements is also supplied. This may include instructions to keep timestamps fresh; or perform format conversions as well as access control data. It can also include storage requirements, for example, speed of access over time, number of replicas, etc. A data management system ensures that these tasks are maintained.

The architecture supports recovery back to the appropriate level of safety after failures and allows operations to continue even if parts of the system have failed.

The proposed architecture provides a distributed platform supporting large scale replication of data and index data. This data is placed at random such that it extremely difficult to predict where particular pieces data are and therefore difficult to attack individual items. These advantages are achieved by the inclusion of an indexing layer that enables management processes and extensible data structures to be created. This enables the architecture to meet the goals of a business level trusted storage service where prior art architectures do not. Having the index layer also allows for the running of ‘healing’ processes such as dealing with missing replicas of index data or the failure of storage sites. The architecture will even allow an index site to be recreated.

The main elements of the above-described system will now be described in more detail.

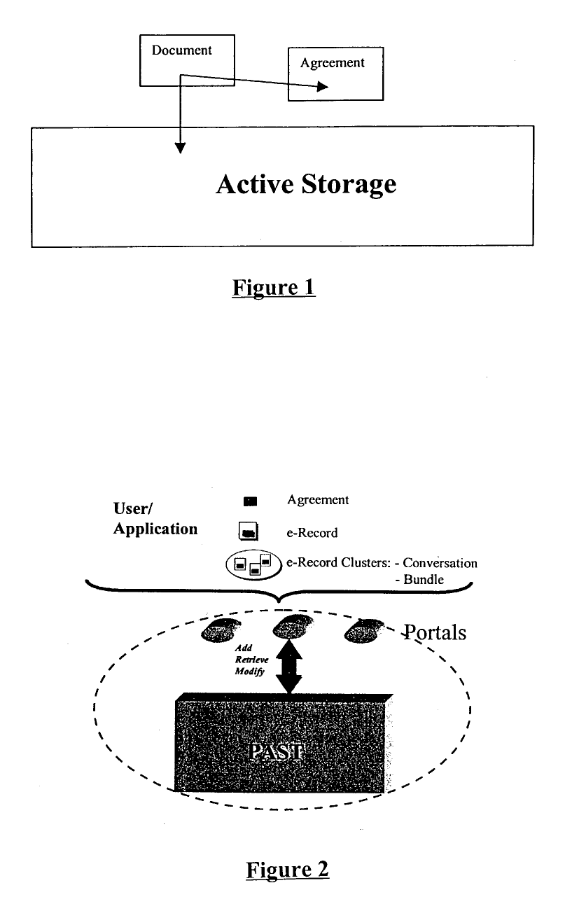

The storage requirements for an arbitrary document can vary enormously. In accordance with the present invention, the storage requirements for a given document, electronic record, message or other piece of data can be specified in a data management program or “agreement” document which covers, for example, the amount of resilience required of the storage, how private it should be kept, access control times and rights and how long the record should be kept (see FIG. 1). The agreement forms a contract, service level agreement, or equivalent (depending on the nature of how the storage service is delivered) between the storage service provider and the owner of the document. The present invention is intended to provide a low level agreement which is derivable from the customer's specification, and which specifies in precise detail how the document should be managed by the storage service throughout its lifetime.

In the following, architectural principles of an active storage service according to an exemplary embodiment of the present invention will be described. Referring to FIG. 2 of the drawings, from a user perspective, the service (termed in this description as “PAST”—Permanent Active Storage Service) is a black box, accessible through portals, each of them providing the API to access basic storage service functions: add, retrieve and extend electronic records. Users are interested in the electronic records they want to store and the flexibility by which they can express storage constraints and management conditions, i.e. the electronic record storage agreement.

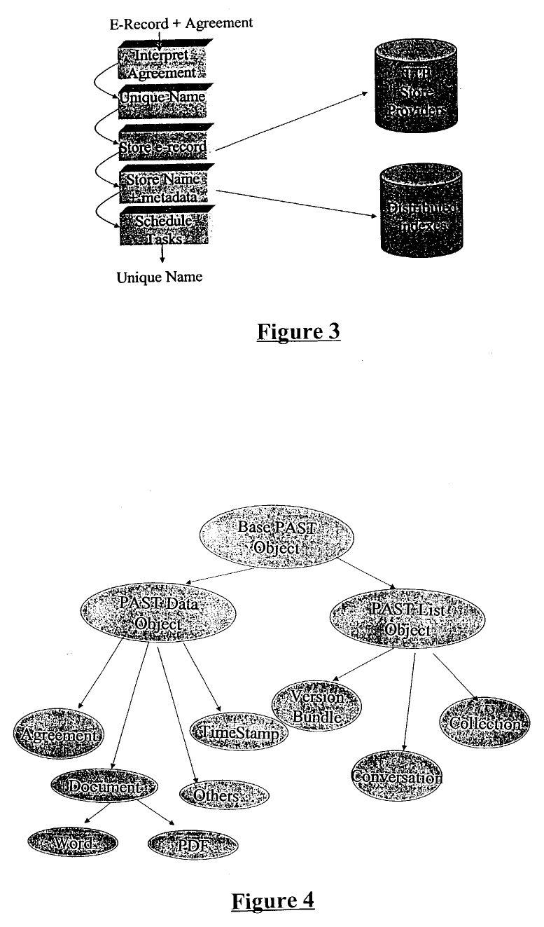

Referring to FIG. 3 of the drawings, from a high level functional perspective, the storage system architecture is designed to support the following electronic record storage processes:

The agreement (specified by the user and associated to an electronic record to be stored) is interpreted by an interpreter in order to define storage and management constraints. A unique name may be generated and associated to the electronic record.

Depending on the agreement constraints, an appropriate set of electronic record replicas are stored in multiple external physical storage sites.

During this process, a lot of metadata is generated, including the electronic record name, the location of its replicas, encryption keys, long-term management tasks, etc. Again depending on the agreement constraints, an appropriate set of metadata replicas is stored in a distributed and heterogeneous set of indexes. Metadata is retrievable by interpreting the unique name associated to the electronic records.

The electronic record name is returned to the user.

Thus, the user has a client side API that allows them to store and manipulate the data within the storage service. The user enters and accesses all data within the service as objects derived from a base object class. For the purposes of this specification, it will be understood that an object is defined as an instance of a class, and a class is defined as a collection of procedures called methods, and the data types they operate on. Thus, this base object class is then specialised to represent different types of data represented within the system. For example, there are sub-classes for agreements, bundles of data, raw binary data, timestamps, collections and conversations.

Referring to FIG. 4 of the drawings, the base object is at the top of the object hierarchy of data, documents and structures within this exemplary embodiment of an active storage service according to the present invention. The base object defines that all data within the service will have a number of properties, including (but not limited to) a name, agreement name, a description and the main body of the data.

In order to create a new data element in the store, the user creates a new base object and they can then set and manipulate all properties except the name. Once satisfied with the data object which has been created, they would call a submit method on the object which submits the object into the storage system and, on completion, sets the name of the object and disables the ability to change the object properties. Under normal operation, the user would refer to the data object using the name generated by the system (and which is guaranteed to be unique). As such, to recover a data object, the user creates a new base object of the appropriate name which causes the user's system to contact a storage system portal and recover a copy of the data that can then be accessed via the object properties.

The “agreement” is a sub-class of the base object that contains information describing how the data must be maintained. This sub-class includes two additional features not present in the base object. Firstly, the data must be agreement data, and secondly, the agreement name property can refer to itself as its own management agreement. This notion of self is essential when it is considered that every electronic document requires an agreement under which it is to be managed. The agreement details class contains a set of properties describing how a document should be stored, which will now be described in more detail.

Digital agreements are the mechanism by which users describe how electronic records have to be managed by a (permanent or long-term) active storage service. In the following, two categories of agreements are described: high-level agreements, defined by a user at the right level of abstraction, and low-level agreements which are programmatically enforceable by the storage service and are generated from the high-level agreements.

Specifically, a low-level agreement contains constraints on how a document or electronic record has to be stored (the number of copies required to be made and stored, degradation thresholds, retention period, etc.) and how it has to be managed over a (possibly) long period of time (time stamp renewal, format renewal, digital signature renewal, etc.).

Each document or record stored in the system is associated to an agreement. It will be appreciated that the system of the present invention supports the definition of fine-grained agreements, i.e. it is possible to define a specific and individual agreement for each stored document, if required.

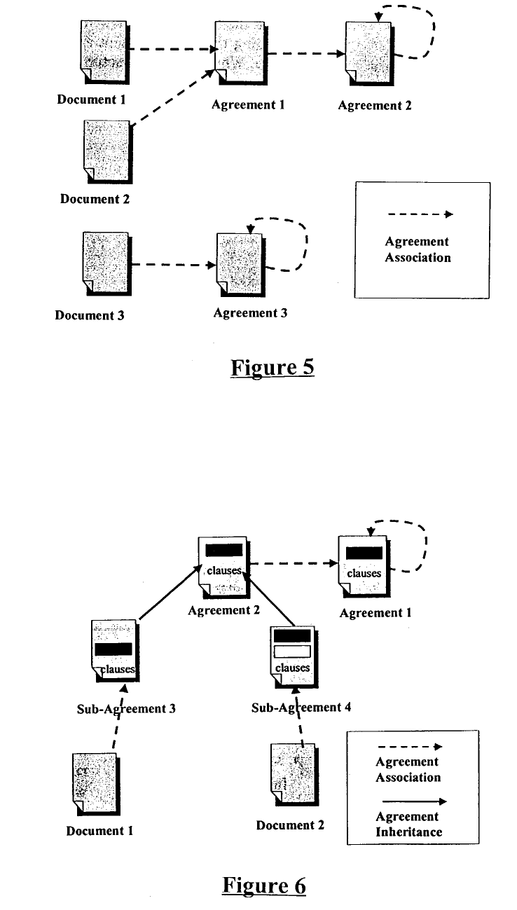

It will be appreciated that an agreement is a document in itself and, as such, it is associated to either another agreement or to itself, as illustrated in FIG. 5 of the drawings. An agreement which is associated to itself is termed a “root agreement”.

From a different perspective, an agreement can be considered as an “object” which contains agreement clauses. Each agreement clause describes a particular management constraint. It is possible to define hierarchies of agreements whose clauses are inherited or overloaded by sub-agreements, as illustrated in FIG. 6 of the drawings.

Thus, each agreement is defined as a collection of clauses describing management constraints and requirements (i.e. attributes) with respect to the associated document. In accordance with this exemplary embodiment of the invention, there may be considered to be at least three different categories of clauses:

Immediate clauses, which describe immediate constraints that need to be satisfied when dealing with the associated document or electronic record. These constraints can be contextual and dependent on the electronic record to which the agreement is associated. Examples of immediate clauses are the ones specifying the storage time, the number of replicas which need to be produced and stored, the selection of storage services, preferences on encryption algorithm, etc.

Action clauses, which are time-based clauses which describe activities that need to be performed periodically, during the whole of the period in which a document is stored by the system. Examples of action clauses are the ones specifying when a document need to be re-timestamped, when a document needs to be re-encrypted, how often document storage location needs to be changed, when and how a document is to be deleted, etc.

Event clauses, which are event-based clauses which describe which event must be trapped and managed during the whole of the period in which a document is stored by the system. An example of an event clause is the renewal of a document format when a new version of the rendering tool becomes available (such that a document created using a particular rendering tool can still be read many years, and versions of the tool, later).

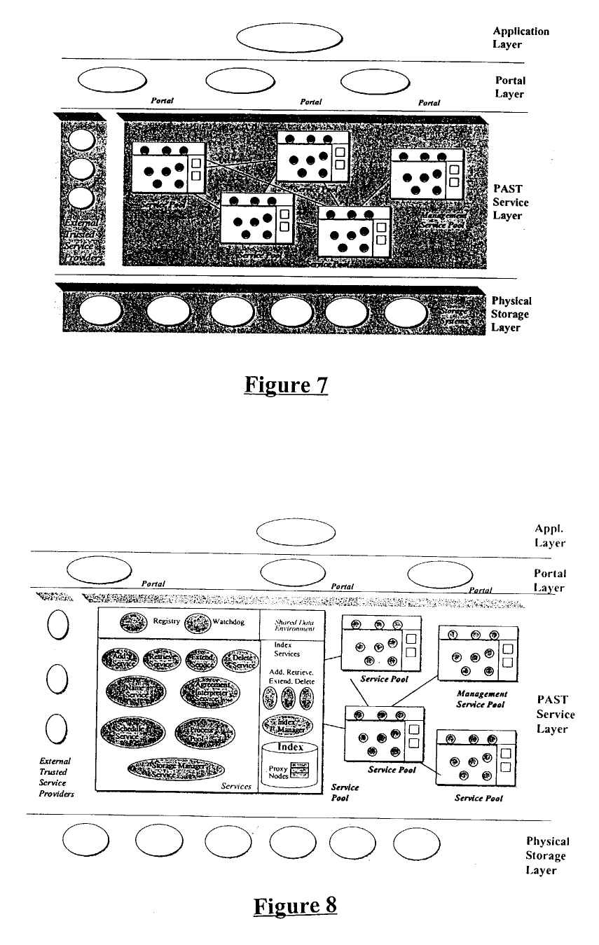

FIG. 7 of the drawings shows a high level view of the architecture of an active storage system according to an exemplary embodiment of the present invention. As shown, the architecture is organised into three main layers:

The Portal Layer is the gateway to access the system services from the external world. As stated above, it exposes to users the API to access the basic system services, namely storage, retrieval, extension and deletion of electronic records. Multiple portals are generally available at any time to applications.

The Service Layer is the layer that supplies the electronic records storage services, management services and longevity services. It is at this level that relevant metadata about stored electronic records are created, managed and stored. This layer is populated by multiple distributed ‘service pools’, each of them running a similar set of basic services. At the same layer are also available services provided by external ‘trusted’ providers. These external services include time-stamping services, certification authorities, trusted content renewal services, etc.

The Physical Storage Layer is the level where electronic records are physically stored. It is populated by a heterogeneous set of storage services. This level is external to the storage system itself, in the sense that multiple external providers can potentially supply these services.

From the architectural point of view, the service layer is the most important because it implements the core system functionalities. In one preferred exemplary embodiment of the present invention, a distributed set of service pools characterise this service layer. FIG. 8 of the drawings provides more details about the contents of a service pool.

Every service pool runs the following services:

Add, retrieval, extension and deletion of electronic records (although it should be appreciated that deletion of a record will only occur if and when this is specified in the associated agreement). These services orchestrate the interactions with other services (both within a service pool and across them) to fulfil users' requests.

Agreement interpretation service, which is the service in charge of interpreting the agreement associated to an electronic record, creating an internal representation and identifying related long-term activities.

Naming service, which is the service in charge of creating a new name for each stored electronic record within the system.

Long-term scheduling service, which is the service in charge of scheduling long-term maintenance and management activities for the stored electronic records.

Process pool, which is a set of support processes used by the service pools to underpin trust services, like time-stamping, re-encryption, electronic record format renewal, etc. Part of such services may be provided by external ‘trusted’ service providers.

Indexing service, which is a distributed service in charge of indexing and managing at least some of the data associated to the stored electronic records.

Storage management service, which is the service that coordinates the interaction with external storage services to store, retrieve, modify and delete electronic records.

Service registration and Watchdogging, which is the service in charge of registering services running in a service pool and making their locations available to other service pools.

Service pools collaborate to fulfil user's requests by minimising the impact of failures. Management Service Pools are deployed within the system to provide service pools with a contact point for failure notifications and support for self-healing management. In addition, management service pools supply the following services:

Storage of configuration data shared among all service pools;

Service to deploy configuration data among all service pools; and

Monitoring services

The architecture is modular, such that each service implements well-defined interfaces and functionalities. The architecture is scalable, such that extra services can relatively easily be added at each level thereof.

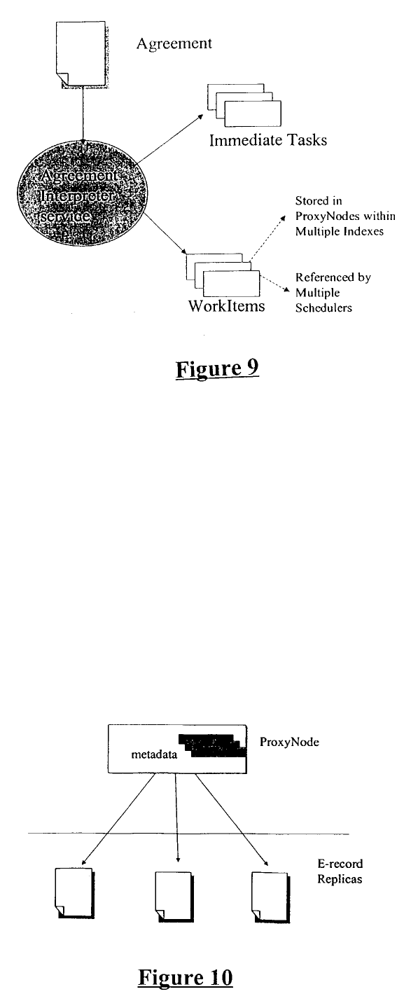

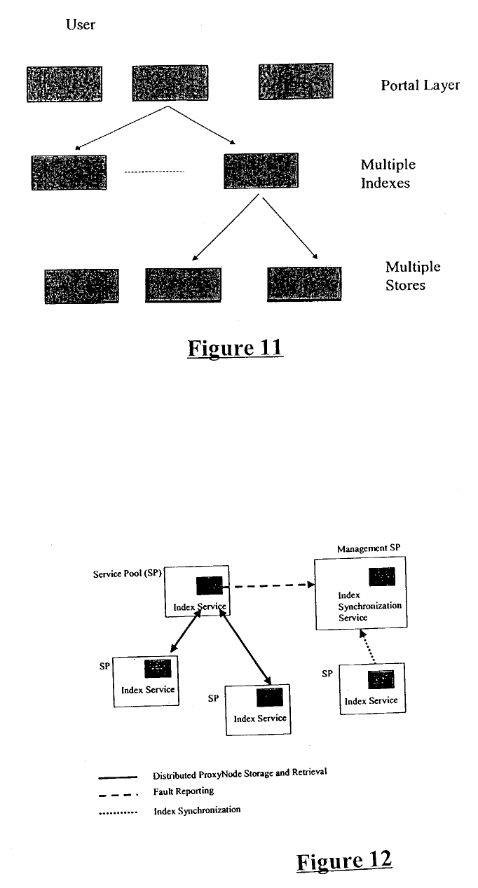

Thus, each service pool within this exemplary embodiment of an active storage system implements an agreement interpreter service. This service interprets the content of an agreement in the context of the associated document (electronic record) and it works out a set of immediate tasks and work items, as illustrated in FIG. 9 of the drawings. Immediate tasks are activities which need to be performed immediately by the system in order to properly store a specific electronic record, such as the need to produce and store replicas thereof across a heterogeneous set of storage sites, etc.

Work items, on the other hand, are programmatically executable items which specify either long-term activities, which need to be done periodically with respect to the electronic record, or events which must be properly managed when they occur. Because of their nature, they need to be stored by the system in a ‘survivable’ way, wherein ‘survivability’ can be defined as the ability of a computing system to provide essential services in the presence of attacks and failures, and/or its ability to recover full services in a timely manner. In order to facilitate this in this exemplary embodiment of the present invention, work items are stored within a proxynode associated to the electronic record. Its survivability is ensured by the replication of the proxynode within multiple indexes randomly chosen by the system. This will be described in more detail later.

Further, work items need to executable when required. As such, a reference to the work items is stored within schedulers (in multiple service pools) along with their execution time. The scheduler will then take care of executing work items according to the constraints it specifies.

The user may be provided with a set of questions/options to be answered/selected in order to configure an agreement to be associated with a document or set of documents.

It will be appreciated that in some circumstances, there maybe multiple agreements associated with a single stored document or set of documents. As such, there may be some conflict between rules specified in each agreement. For example, one agreement may specify that a time stamp is to be renewed every six months, where another agreement associated with the same document may specify that the time stamp is to be renewed annually. In this case, one embodiment of the present invention incorporates a set of rules for resolving such conflict, such rules preferably being based on the most sensible and safe resolution, according to the context of the clause (i.e. the rule mechanism might beneficially be dealt with using logical constraints). Thus, in the case of regular renewal of time stamps, digital signatures, etc., the appropriate rule might specify that the shortest period is to be selected in the case of conflict.

The process of storing electronic records within a storage service according to this exemplary embodiment of the invention involves the generation of data that is strictly coupled to and relevant for those electronic records. Such data contains a wide range of information, from the location of stored electronic record replicas to long-term management activities planned for that electronic record (i.e. the work items determined to be required by an agreement by the agreement interpretation service).

The above-mentioned data needs to be properly stored and kept in a consistent state by the storage service in order to allow the associated electronic record to be retrievable and accessible for future operations. In addition, the requirement of survivability over a long period of time is required to be fully satisfied. In the following, mechanisms used in an exemplary embodiment of the invention to deal with survivability and consistency management of electronic records data. The concept of a ‘proxynode’ (referred to above) is introduced, and a distributed index service for proxynodes storage and management is described, along with relevant algorithms.

The term ‘proxynode’ is employed herein to mean a data structure containing metadata about a stored electronic record (see FIG. 10). In the context of this exemplary embodiment of the present invention, such data information includes the name of the electronic record, information about the electronic record replicas (e.g. their locations, encryption keys, etc.), work items (referred to and explained in detail above), the current version of the electronic record (with reference, for example, to its rendering tool), a counter of references to the electronic record, a deletion flag indicating that the associated electronic record should be deleted, and the last date and time of modification of the proxynode.

In the context of the present invention, a proxynode is a dynamic entity: its content can vary quite frequently to reflect changes made to the associated electronic record. It must be consistently updated and stored such that it can survive at least as long as the associated electronic record. Proxynode replicas need to be kept consistent in case multiple applications/users want to concurrently access them or in case of faults which could cause the destruction of some replicas or delay their synchronisation.

The distributed index service referred to above can be designed to overcome some of the above problems. In general, the aim of such a distributed index service is to store and retrieve proxynodes, make them accessible to users and guarantee their survivability and consistency, to the greatest extent possible. FIG. 12 of the drawings provides an overview of the distributed index service components.

The basic principle underpinning the distributed index service is that the functions of storing and retrieving proxynodes must, to the greatest extent possible, always be available to users, in spite of local faults. The service is beneficially able to recognise the occurrence of such faults, keep track of them and repair them in the background, without service disruption.

In order to satisfy this requirement, the service according to this exemplary embodiment of the present invention is built by composing independent index services (run by service pools) and index synchronisation services (run by the management service pool). Index services cooperate with each other to store and retrieve multiple local copies of the same proxynode. At any time, one of the involved index services leads the distributed storage or retrieval operations. The choice of the leader is purely dependent on the (randomly generated) name of the proxynode and its availability.

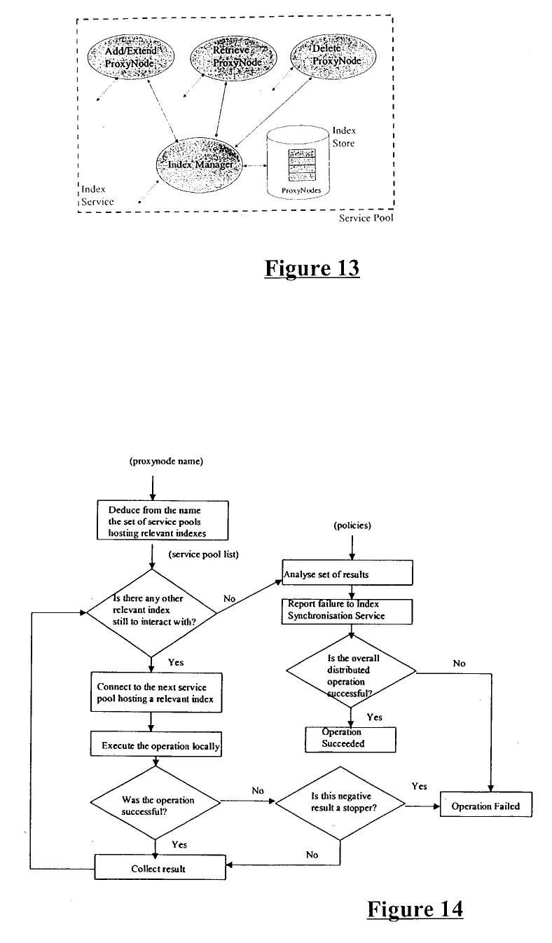

Index services “logically” lock all the proxynodes related to an electronic record to keep them consistent when they are modified, in case of concurrent access. In case of faults which prevent access to some proxynodes, error notifications are communicated by the leader to a “central” index synchronisation service. Each index service periodically synchronises with this service in order to repair its damages or update the content and state of proxynodes. The functionalities of the index service will now be described with reference to FIG. 13 of the drawings.

Referring to FIG. 13, the index service, which is the basic component of the distributed index service, is in charge of dealing with the local management of a proxynode and interacting with other relevant index services (containing replicas of the same proxynode) to provide the following distributed functionalities:

Storage of a proxynode within the relevant index services;

Provision of access to a proxynode in a mutually exclusive way, by locking its content within all the relevant index services;

Update or delete a proxynode across multiple index services;

Annotation and reporting of possible faults occurring during any of the above cases to an index synchronisation service.

The basic components of the index service are as follows:

The Index Store, which is a database or repository used to store proxynodes along with management data, like tokens containing locking information, timestamp, date and time of last changes, etc.

The Index Manager, which is a service that manages the interactions with the local index store: add, retrieve, modify and delete proxynodes. These local interactions are transactional (either commit an operation or roll it back) and based on mutually exclusive access to rows of database tables. The index manager implements a dynamic queue mechanism to deal with multiple concurrent access requests to the same resources. The index manager also implements synchronisation mechanisms to synchronise an out-of-date index store, by interacting with the index synchronisation service and other relevant index managers.

The ‘Add Proxynode’ Service, which is a service that manages the process of adding or extending the content of a proxynode, for all indexes storing a copy of the proxynode (the set of relevant indexes is deduced by the proxynode name). In particular, it provides the following functions:

Add Proxynode: this service interacts with the relevant set of index managers to store a proxynode. The operation is managed in a non-transactional way. Should any of the index managers not be available (for example, in the case of a fault) the service takes note of the problem and it communicates it to the index synchronisation service. This phase is typically followed by a “lazy” re-synchronisation of the out-of-synch proxynodes.

Extend Proxynode: this service interacts with the relevant set of index managers to update a proxynode. The proxynode had to be previously retrieved in a “logically locking” mode to ensure its consistency. Should any of the index managers not be available, the service takes note of the problem and communicates it to the index synchronisation service. This phase is typically followed by a “lazy” re-synchronisation of the out-of-synch proxynodes.

Retrieve Proxynode Service: this is the service that manages the process of retrieving a proxynode from a distributed set of relevant index managers. The system “logically” locks the proxynode across multiple indexes to preserve its consistency. It retrieves all of the copies of the proxynodes and it returns the most recent version (ideally, all copies of a proxynode should have the same version). This operation is done in a “non-transactional” way. It will be understood that the term “logical” is intended to refer to the fact that the locking process is controlled and managed at the service level using metadata information on a distributed set of resources. It will also be understood that the term “non-transactional” is intended to refer to the fact that the locking process of proxynodes can succeed in spite of localised faults. Should any fault occur, the service takes note of the problems and communicates them to the index synchronisation service. This phase is typically followed by a “lazy” re-synchronisation of the out-of-synch proxynodes.

Delete Proxynode Service: this is the service that deletes a proxynode from the distributed set of relevant index managers. The proxynode had to be previously “logically” locked to preserve its consistency. A proxynode can be deleted only if this operation is permitted by the user agreement associated with a particular document. The operation succeeds in spite of localised faults. Should any fault occur, the service takes note of the problems and communicates them to the index synchronisation service. This phase is typically followed by a “lazy” re-synchronisation of the out-of-synch proxynodes.

The algorithms underpinning the “non-transactional” management of index operations, the “logical locking” of proxynodes and the “lazy” synchronisation of indexes after faults will now be described in more detail.

As explained above, the system according to this exemplary embodiment of the present invention implements the operations of adding, retrieving, extending and deleting proxynodes within sets of indexes (hosted by different service pools) in a “non-transactional” way.

Traditional transactional systems label an operation as failed and backtrack it if at least one of the involved sub-operations fails. In this exemplary embodiment of the present invention, partial failures do not necessarily determine the failure of the higher-level operation. Policies can be defined to describe which results can be classified as successful. A simple policy could, for example, state that an operation is successful if it succeeds for a well-defined percentage of the involved indexes.

Each of the indexing operations (add/extend/retrieve/delete proxynode) involves the execution of a set of simple local operations within all the service pools hosting relevant indexes. For each of them, the leading service is able to:

detect faults that affect either the whole service pool or single services within it (specifically the index manager and the index store);

report them to the central index synchronisation service;

fulfil (if possible) the current operation by interacting with the next relevant service pools;

label the task as successful if at least a (predefined) part of the operations succeeded.

Particular operations, like the retrieval of a proxynode, might fail not because of faults but because the unavailability of the requested resource. This might be due to the fact that the proxynode has been “logically” locked by some other application. In such a case, mthe requesting application is queued for a predefined period of time and for a predefined set of attempts. Should all such attempts fail, the operation fails, as illustrated in the flow diagram of FIG. 14.

It will be noted that the “central” index synchronisation service is only notified in the event that a real problem occurs, i.e. due to failures of part of the service infrastructure. No such notification is generated if resources are unavailable because they are locked by other applications.

The operation of retrieving a proxynode (for extension or deletion purposes) requires a mutually exclusive access to the proxynode. As multiple replicas of a proxynode are available on multiple indexes, the mutually exclusive access must be guaranteed for all such replicas. This is achieved in this exemplary embodiment of the present invention by “logically” locking all of the replicas of a proxynode.

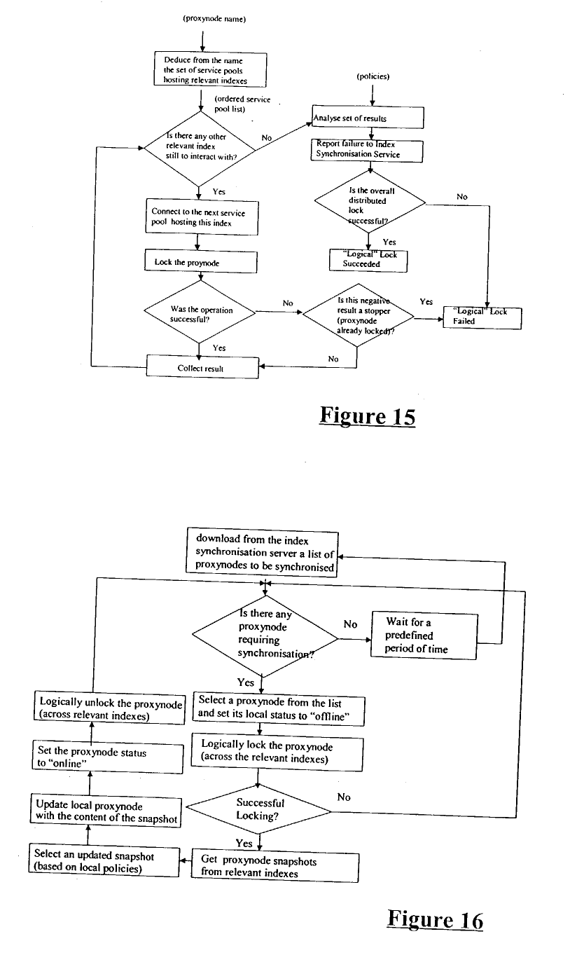

As the name of a proxynode contains an ordered list of all of the service pools that host the proxynode replicas, the implemented algorithm “locks” these single proxynode replicas by rigorously respecting this sequence. In the distributed index system of this exemplary embodiment of the present invention, a single proxynode replica is locked by setting to “locked” a flag within the metadata associated to the replica (and stored in the index store). The algorithm illustrated in FIG. 15 assumes that each index manager the service manager interacts with during the logical lock (and unlock) of a proxynode, either contains updated information about the proxynode or will refuse the access to the proxynode.

During the locking process, some of the involved proxynode replicas might not be accessible because of faults, in which case notification of the problem is sent to the central index synchronisation service.

A similar algorithm may be implemented to “logically” unlock a proxynode and, to avoid deadlock problems, the system is preferably arranged to unlock. proxynode replicas in the reverse order of the locking sequence.

It will be apparent from the above description that the central index synchronisation service is a fundamental component of the distributed index service of this exemplary embodiment of the present invention. On the one hand, the add/retrieve/extend/delete proxynode services notify the central synchronisation service every time they encounter faults related to proxynodes. Independently, and according to the type of fault which is encountered (e.g. index manager unavailable, proxynode unavailable, proxynode corrupted, etc.), a notification is generated containing the name of the proxynode, the name of the service pool hosting the faulty index manager and the kind of problem.

On the other hand, index managers contact the central index synchronisation service to verify if there are any local proxynodes requiring synchronisation. These interactions happen both during the bootstrapping phase and periodically, at run time. In particular, the latter kind of interaction is useful to prevent out-of-synch problems due to temporary network isolation of the service pool running the index manager.

Referring to FIG. 16 of the drawings, the synchronisation of distributed indexes is important in order to maintain consistency among the replicas of each proxynode. When an index manager detects that one of its proxynodes is out-of-synch, it immediately labels this proxynode as “offline” within the local index store. This means that any attempt to access its content is denied. Then it tries to “logically” lock all the replicas of the proxynode in order to have exclusive access to its content. The index manager “logically” locks a proxynode by interacting with the relevant peers (index managers identified by the name of the proxynode). If the lock does not succeed (because the proxynode is already locked) it queues this activity and retries later.

If it succeeds, it retrieves proxynode snapshots (proxynode and its metadata) from all the relevant (and accessible) index managers and analyses the result. Depending on the local policies, the index manager selects a proxynode snapshot (perhaps based on the highest version or some form of voting mechanism), updates its local copy, sets the proxynode to the “online” status and unlocks the proxynode.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. A digital data storage system, arranged to receive one or more pieces of digital data for storage in an electronic data storage location, and to store in association with said one or more pieces of digital data, metadata defining a predetermined data storage management strategy with respect to said one or more pieces of digital data, said metadata defining one or more actions required to be taken by said storage system in respect of said one or more pieces of digital data in order to comply with said data storage management strategy, the system comprising configuring apparatus for configuring said data storage management strategy by defining or specifying at least some of said actions individually according to specific requirements related to said one or more pieces of digital data.

2. A digital data storage system according to claim 1, wherein said data storage management strategy is stored in the form of a digital document associated to said one or more pieces of digital data (which may also be stored in the form of one or more digital documents).

3. A digital data storage system according to claim 2, wherein a data management strategy is stored in the form of a digital document associated to a single piece of digital data.

4. A digital data storage system according to claim 2, wherein a data management strategy is stored in the form of a digital document associated to a plurality of pieces of digital data.

5. A digital data storage system according to claim 1, wherein said one or more pieces of digital data is digitally time-date stamped prior to storage thereof, and said data storage management strategy specifies as an action that said digital time-date stamp must be renewed periodically, the frequency of renewal being specified according to specific requirements related to said one or more pieces of digital data.

6. A digital data storage system according to claim 1, wherein said one or more pieces of digital data is digitally signed prior to storage thereof, and said data storage management strategy specifies as an action that said digital signature must be renewed periodically, the frequency of renewal being specified according to specific requirements related to said one or more pieces of digital data.

7. A digital data storage system according to claim 1, wherein a first data storage management strategy has associated therewith a second data storage management strategy defining one or more actions to be taken by said storage system to comply with said first data storage management strategy.

8. A digital data storage system according to claim 1, wherein a data storage management strategy defines one or more actions to be taken in respect thereof by said storage system.

9. A digital data storage system according to claim 1, comprising apparatus for defining a hierarchy of data storage management strategies ranging from those including relatively general actions to those including more specific actions to be taken in respect of said one or more pieces of data.

10. A digital data storage system according to claim 1, wherein two or more data storage management strategies are defined for and stored in association with the same one or more pieces of digital data.

11. A digital data storage system according to claim 10, comprising apparatus for applying one or more predefined rules to said data storage management strategies in the event of a conflict between two or more actions defined therein.

12. A digital data storage system according to claim 1, comprising apparatus for defining a data storage management strategy to be applied to all pieces of digital data of a specified class or type.

13. A digital storage system according to claim 1, comprising a service layer for providing storage and management services, as specified by a user, wherein said service layer comprises a plurality of service modules, each of which provides a different service to the user.

14. A digital storage system according to claim 13, comprising three operating levels, namely a portal layer, said service layer, and a physical storage layer, where said one or more pieces of data are actually stored, said portal layer permitting access to said system by a user and providing a routing system to the correct storage and/or management service provided by said service layer..

15. A digital data storage system according to claim 1, wherein data is stored, in association with said one or more pieces of digital data, which includes one or more of a name allocated to said one or more pieces of digital data, information relating to one or more replicas of said one or more pieces of digital data, and information relating to actions defined by said data storage management strategy.

16. A digital data storage system according to claim 15, wherein said name contains sufficient data to derive a mapping to said one or more pieces of digital data associated therewith.

17. A digital data storage system according to claim 15, wherein at least said name data is stored in a dedicated data structure, herein referred to as a proxynode.

18. A digital data storage system according to claim 17, wherein a plurality of proxynodes are provided for each piece, set or class or type of data, the system comprising apparatus for logically locking all of the proxynodes relating to a piece, set or class or type of data when the metadata stored therein is modified so as to prevent concurrent access thereto and to maintain their consistency with each other.

19. A method of digital data storage, the method comprising the steps of receiving one or more pieces of digital data for storage in a storage means, storing in association with said one or more pieces of digital data metadata defining a predetermined data storage management strategy, said data storage management strategy defining one or more actions required to be taken in respect of said one or more pieces of digital data in order to comply with said data storage management strategy, implementing said constraints as defined by said data storage management strategy, the method further comprising the step of configuring said data storage management strategy by defining or specifying at least some of said one or more actions individually according to specific requirements related to said one or more pieces of digital data.

20. A digital data storage system, arranged to receive one or more digital documents for storage in a memory device, generate metadata defining a predetermined document storage management strategy with respect to said one or more digital documents, and store said metadata together with said respective one or more digital documents, said metadata defining one or more operations required to be performed by said storage system in respect of said one or more digital documents in order to comply with said document storage management strategy, and the system comprising a configuring system for configuring said document storage management strategy by defining or specifying at least some of said operations individually according to specific requirements relating to said one or more digital documents.
